(19) United States
(12) Patent Application Publication
(10) Pub. No.: US 2010/0279079 A1
(43) Pub. Date: Nov. 4, 2010

(54) LASER-SENSITIVE RECORDING MATERIALS HAVING AN UNDERCOATING LAYER

(76) Inventors: Jonathan Campbell, Riehen (CH); Robert Montgomery O'Neill, Manchester (GB)

Correspondence Address: BASF Corporation;Patent Department, 500 White Plains Road, P.O. Box 2005, Tarrytown, NY, 10591, US

(21) Appl. No.: 12/528,352

(22) PCT Filed: Feb. 27, 2008
(86) PCT No.: PCT/EP08/52332

§ 371 Date: Aug. 24, 2009

(30) Foreign Application Priority Data
Mar. 8, 2007 (EP) 07103770.9

(51) Int. Cl. B41M 5/28; B05D 1/36; B32B 3/10

(52) U.S. Cl. 428/195.1; 503/200; 427/150; 503/201

(57) ABSTRACT

The present invention provides a laser-sensitive recording material, which comprises a substrate being coated with a recording layer and an undercoating layer, wherein the recording layer undergoes a colour change upon heat treatment produced by laser irradiation and wherein the undercoating layer comprises a pigment with the proviso that the system of the recording layer that undergoes a colour change upon heat treatment produced by laser irradiation does not comprise an organic leuco dye and an organic colour developer, a process for its preparation, a process for marking the laser-sensitive recording material and the marked laser-sensitive recording material.

The present invention refers to a laser-sensitive recording material, to a process for its preparation, to a process for marking the laser-sensitive recording material and to the marked laser-sensitive recording material.

Packaging usually needs to be marked with information such as logos, bar codes, expiry dates or batch numbers. One way to achieve this is by coating the packaging with a composition, which upon heat treatment forms a visible marking.

It is an object of the present invention to provide a laser-sensitive recording material comprising a recording layer and an undercoating layer, wherein the recording layer undergoes a colour change upon heat treatment supplied by laser irradiation, and wherein the undercoating layer enhances the performance of the laser irradiation. The performance of the laser irradiation is enhanced, for example, when the density of the produced colour is increased at a given combination of irradiation power and time or when a given density of the produced colour can be achieved with a combination of lower irradiation power and/or less time.

This object is solved by the laser-sensitive recording material of claim 1, the processes of claims 5 and 6 and the marked laser-sensitive recording material of claim 7.

The laser-sensitive recording material of the present invention comprises a substrate being coated with a recording layer and an undercoating layer, wherein the recording layer comprises a system that undergoes a colour change upon heat treatment produced by laser irradiation and wherein the undercoating layer comprises a pigment with the proviso that the system of the recording layer that undergoes a colour change upon heat treatment produced by laser irradiation does not comprise an organic leuco dye and an organic colour developer.

An organic leuco dye is an organic compound which can acquire two forms, one of which is colourless.

Examples of organic leuco dyes are phthalides, azaphthalides, fluorans, triarylmethanes, benzoxazines, quinazolines, spirooxazines, spiropyrans, spiroisobenzofurans, quinones, thiazines or oxazines or mixtures thereof.

Examples of phthalides are crystal violet lactone (3,3-bis(p-dimethylaminophenyl)-6-dimethyl-aminophthalide), 3,3-bis(p-dimethylaminophenyl)phthalide, 3,3-bis(1-ethyl-2-methylindol-3-yl)phthalide, 3,3-bis(1-octyl-2-methylindol-3-yl)phthalide, 3-(4-diethylaminophenyl)-3-(1-ethyl-2-methylindol-3-yl)-phthalide, 7-(N-ethyl-N-isopentylamino)-3-methyl-1-phenyl-spiro[4H-chromeno[2,3-c]pyrazole-4(1H)-3′phthalide, 3,6,6′-tris(dimethylamino)spiro-[fluorene-9,3′-phthalide], 3,6,6′-tris(diethylamino)spiro[fluorene-9,3′-phthalide], 3,3-bis-[2-(p-dimethylaminophenyl)-2-(p-methoxyphenypethenyl-4,5,6,7-tetrabromophthalide, 3,3-bis[2-(p-dimethylaminophenyl)-2-(p-methoxyphenyl)ethenyl-4,5,6,7-tetrachlorophthalide, 3,3-bis[1,1-bis(4-pyrrolidinophenyl)ethylene-2-yl]-4,5,6,7-tetrabromophthalide and 3,3-bis-[1-(4-methoxyphenyl)-1-(4-pyrridinophenypethylene-2-yl]-4,5,6,7-tetrachlorophthalide.

Examples of azaphthalides are 3-(4-diethylamino-2-ethoxyphenyl)-3-(1-ethyl-2-methylindol-3-yl)-4-azaphthalide, 3-(4-diethylamino-2-ethoxyphenyl)-3-(1-octyl-2-methylindol-3-yl)-4-aza-phthalide and 3-(4-N-cyclohexy1N-ethylamino-2-methoxyphenyl)-3-(1-ethyl-2-methylindol-3-yl)-4-azaphthalide.

Examples of fluorans are are 3-di(ethyl)amino-6-methyl-7-(tert-butoxycarbonyl)anilinofluoran, 3-diethylamino-7-dibenzylaminofluoran, 3-dibutylamino-7-di benzylaminofluoran, 3-diethyl-amino-6-methyl-7-(dibenzylamino)fluoran, 3-diethylamino-6-methylfluoran, 3-diethylamino-6-chloro-7-methylfluoran, 3-diethylamino-6-methyl-7-chlorofluoran, 3-diethylamino-7-tert-butylfluoran, 3-diethylamino-7-carboxyethylfluoran, 3-diethylamino-7-methylfluoran, 3-diethylamino-6,8-dimethylfluoran, 3-diethylamino-7-chlorofluoran, 3-dibutylamino-6-methyl-fluoran, 3-cyclohexylamino-6-chlorofluoran, 3-diethylamino-benzo[a]fluoran, 3-diethylamino-benzo[c]fluoran, 3-dimethylamino-6-methyl-7-anilinofluoran, 3-diethylamino-6-methyl-7-anilinofluoran, 3-diethylamino-6-methyl-7-(2,4-dimethylanilino)fluoran, 3-diethylamino-6-methyl-7-(3-trifluoromethylanilino)fluoran, 3-diethylamino-6-methyl-7-(2-chloroanilino)-fluoran, 3-diethylamino-6-methyl-7-(p-chloroanilino)fluoran, 3-diethylamino-6-methy1-7-(2-fluoroanilino)fluoran, 3-diethylamino-6-methyl-7-(p-octylanilino)fluoran, 3-diethylamino-7-(p-octylanilino)fluoran, 3-diethylamino-6-methyl-7-(p-methylanilino)fluoran, 3-diethylamino-6-ethoxyethyl-7-anilinofluoran, 3-diethylamino-6-methyl-7-(3-methylanilino)fluoran, 3-diethyl-amino-7-(3-trifluoromethylanilino)fluoran, 3-diethylamino-7-(2-chloroanilino)fluoran, 3-diethyl-amino-7-(2-fluoroanilino)fluoran, 3-diethylamino-6-chloro-7-anilinofluoran, 3-dibutylamino-6-methyl-7-anilinofluoran, 3-dibutylamino-6-methyl-7-(2,4-dimethylanilino)fluoran, 3-dibutyl-amino-6-methyl-7-(2-chloroanilino)fluoran, 3-dibutylamino-6-methyl-7-(4-chloroanilino)-fluoran, 3-dibutylamino-6-methyl-7-(2-fluoroanilino)fluoran, 3-dibutylamino-6-methyl-7-(3-tri-fluoromethylanilino)fluoran, 3-dibutylamino-6-ethoxyethyl-7-anilinofluoran, 3-dibutylamino-6-chloro-anilinofluoran, 3-dibutylamino-6-methyl-7-(4-methylanilino)fluoran, 3-dibutylamino-7-(2-chloroanilino)fluoran, 3-dibutylamino-7-(2-fluoroanilino)fluoran, 3-dipentylamino-6-methyl-7-anilinofluoran, 3-dipentylamino-6-methyl-7-(4-2-chloroanilino)fluoran, 3-dipentyl-amino-7-(3-trifluoromethylanilino)fluoran, 3-dipentylamino-6-chloro-7-anilinofluoran, 3-dipentylamino-7-(4-chloroanilino)fluoran, 3-pyrrolidino-6-methyl-7-anilinofluoran, 3-piperidino-6-methyl-7-anilinofluoran, 3-(N-methyl-N-propylamino)-6-methyl-7-anilinofluoran, 3-(N-methyl-N-cyclohexylamino)-6-methyl-7-anilinofluoran, 3-(N-ethyl-N-cyclohexylamino)-6-methyl-7-anilinofluoran, 3-(N-ethyl-N-hexylamlno)-7-anilinofluoran, 3-(N-ethyl-p-toluldino)-amino-6-methyl-7-anilinofluoran, 3-(N-ethyl-p-toluidino)amino-7-methylfluoran, 3-(N-ethyl-N-isoamylamino)-6-methyl-7-anilinofluoran, 3-(N-ethyl-N-lsoamylamino)-7-(2-chloroanilino)-fluoran, 3-(N-ethyl-N-isoamylamino)-6-chloro-7-anilinofluoran, 3-(N-ethyl-N-tetrahydrofurfuryl-amino)-6-methyl-7-anilinofluoran, 3-(N-ethyl-N-isobutylamino)-6-methyl-7-anilinofluoran, 3-(N-butyl-N-isoamylamino)-6-methyl-7-anilinofluoran, 3-(N-isopropyl-N-3-pentylamino)-6-methyl-7-anilinofluoran, 3-(N-ethyl-N-ethoxypropylamino)-6-methyl-7-anilinofluoran, 2-methyl-6-p-(p-dimethylaminophenyl)aminoanilinofluoran, 2-methoxy-6-p-(p-dimethyl-aminophenyl)aminoanilinofluoran, 2-chloro-3-methyl-6-p-(p-phenylaminophenyl)amino-anilinofluoran, 2-diethylamino-6-p-(p-dimethylaminophenyl)aminoanilinofluoran, 2-phenyl-6-methyl-6-p-(p-phenylaminophenyl)aminoanilinofluoran, 2-benzyl-6-p-(p-phenylamino-phenyl)aminoanilinofluoran, 3-methyl-6-p-(p-dimethylaminophenyl)aminoanilinofluoran, 3-diethylamino-6-p-(p-diethylaminophenyl)aminoanilinofluoran, 3-diethylamino-6-p-(p-dibutyl-aminophenyl)aminoanilinofluoran and 2,4-dimethyl-6-[(4-dimethylamino)anilino]fluoran.

Examples of benzoxazines are 2-phenyl-4-(4-diethylaminophenyl)-4-(4-methoxyphenyl) 6-methyl-7-dimethylamino-3,1-benzoxazine and 2-phenyl-4-(4-diethylaminophenyl)-4-(4-methoxyphenyl)-8-methyl-7-dimethylamino-3,1-benzoxazine.

An example of a quinazoline is 4,4′-methylethylidene)bis(4,1-phenyleneoxy-4,2-quina-zolinediyMbis[N,N-diethylbenzeneamine]. An example of a triarylmethane is bis(N-methyldl-phenylamine)-4-yl-(N-butylcarbazole)-3-yl-methane.

Examples of spiropyrans are 1′, 3′, 3′-trimethylspiro[2H-1-benzopyran-2,2′-indoline], 1,3,3-tri-methylspiro[indoline-2,3′-[3H]naphth[2,1-13][1,4]oxazine] and 1′, 3′, 3′-trimethylspiro-[2H-1-benzothiopyran-2,2′-indoline]. Examples of spiroisobenzofurans are 6′-(dipentylamino)-3′-methyl-2′-(phenylamino)-spiro[isobenzofuran-1(3H), 9′-[9H]xanthen]-3-one and spiro[isobenzofuran-1(3H), 9′49H]xanthen]-3-one-6′-(diethylamino)-3′-methyl-2′-(3-tolyl-amino).

An example of a quinone is hematoxyline. An example of an oxazine is 3,7-bis(dimethyl-amino)-10-benzoylphenoxazine. An example of a thiazine is 3,7-bis(dimethylamino)-10-benzoylphenothiazine.

Further examples of organic leuco dyes are mentioned in EP 0 366 461 A1 on page 13 lines 8 to 51.

Examples of organic colour developers are are phenolic compounds such as 4,4′-iso-propylidenediphenol (Bisphenol A), bis(4-hydroxyphenyl)acetic acid butyl ester, 2,2-bis-(4-hydroxyphenyl)-4-methylpentane, 2,2-bis(4-hydroxyphenyl)propane, 4,4′-dihydroxy-diphenylsulfone, 2,4′-dihydroxydiphenylsulfone, bis(3-allyl-4-hydroxyphenyl)sulfone, 4-hydroxy-4′-methyldiphenylsulfone, 1,1-bis(4-hydroxyphenyl)-1-phenylethane, 1,4-bis[α-methyl-α-(4′-hydroxyphenypethyl]benzene, 4-[(4-(1-methylethoxy)phenyl)-sulfonyl]phenol and N-(2-hydroxyphenyl)-2-[(4-hydroxyphenyl)thio]acetamide; and compounds having a urea-group or ureido-group such as N-(p-toluenesulfonyl)-N′-(3-p-toluenesulfonyloxy)phenyl) urea, N-p-tolylsulfonyl-N′-phenylurea, 4,4′-N-p-tolylsulfonyl-N′-p-butoxyphenylurea and bis[(4-methyl-3-phenoxycarbonylaminophenyl)ureido]diphenyl-methane and zinc salts of aromatic carboxylic acids such as zinc 4-[2-(p-methoxyphenoxy)-ethyloxy]salicylate, zinc 4-[3-(p-tolylsulfonyl)propyloxy]salicylate and zinc 5-[p-(2-p-methoxy-phenoxyethoxy)cumyl]salicylate.

Further examples of organic colour developers are mentioned in EP 0 366 461 A1 on page 13 line 53 to page 16 line 30.

The pigment usually absorbs and/or reflects the specific wavelength of the laser irradiation.

The pigment can be organic or inorganic.

Examples of organic pigments are polystyrene resin, urea-formaldehyde resin and hollow plastic pigment.

Typical examples of hollow plastic pigments are particles having a shell made from acrylic-based resin, styrene-based resin or vinylidene chloride-based resin. Typically, the volume-based void percentage of the hollow plastic pigments is from about 50 to 99%. The hollow plastic pigments may be expandabe or not-expandable upon heat treatment. The average outside diameter of not-expandable hollow plastic pigments may be in the range of from 0.5 to 10 μm, preferably of from 1 to 5 μm. The outside diameter of expandable hollow plastic pigments may be in the range of from 0.1 to 5 μm. When an undercoating layer comprising expandable hollow plastic pigmemt is subjected to heat treatment, the particles may expand to an average outside diameter in the range of from 1 to 30 μm. An example of a hollow plastic pigment that is expandable upon heat treatment is a particle having a vinylidene chloride-based resin shell and butane gas as fill material.

Examples of inorganic pigments are kaolin, calcined kaolin, mica, aluminum oxide, aluminum hydroxide, aluminum silicates, talc, amorphous silica, colloidal silicon dioxide, titanium dioxide, calcium carbonate (ground and precipitated), calcium silicate and barium sulfate.

Preferably, the pigment is an inorganic pigment.

More preferably, the pigment is selected from the group consisting of kaolin, calcined kaolin, mica, aluminum oxide, aluminum hydroxide, aluminum silicates, talc, amorphous silica and colloidal silicon dioxide.

Most preferred pigments are selected from the group consisting of calcinated kaolin, aluminium hydroxide, talc and amorphous silica.

Preferably, the undercoating layer can also comprise a polymeric binder.

Examples of polymeric binders are acrylic polymers, styrene polymers and hydrogenated products thereof, vinyl polymers and derivatives thereof, polyolefins and hydrogenated or epoxidized products thereof, aldehyde polymers, epoxide polymers, polyamides, polyesters, polyurethanes, sulfone-based polymers and natural polymers and derivatives thereof. The polymeric binder can also be a mixture of polymeric binders.

Acrylic polymers can be polymers formed from at least one acrylic monomer or from at least one acrylic monomer and at least one other ethylenically unsaturated polymer such as a styrene monomer, vinyl monomer, olefin monomer or maleic monomer.

Examples of acrylic monomers are (meth)acrylic acid or salts thereof, (meth)acrylamide, (meth)acrylonitrile, C₁₋₆-alkyl (meth)acrylates such as ethyl (meth)acrylate, butyl (meth)acrylate or hexyl (meth)acrylate, 2-ethylhexyl (meth)acrylate, substituted C₁₋₆-alkyl (meth)acrylates such as glycidyl methacrylate and acetoacetoxyethyl methacrylate, di(C₁₋₄-alkylamino)C₁₋₆-alkyl (meth)acrylates such as dimethylaminoethyl acrylate or diethylaminoethyl acrylate, amides formed from C₁₋₄-alkylamines, substituted C₁₋₆-alkyl-amines such as 2-amino-2-methyl-1-propane sulfonic acid, ammonium salt, or di(C₁₋₄-alkyl-amino)C₁₋₆-alkylamines and (meth)acrylic acid and C₁₋₄-alkyl halide adducts thereof.

Examples of styrene monomers are styrene, 4-methylstyrene and 4-vinylbiphenyl. Examples of vinyl monomers are vinyl alcohol, vinyl chloride, vinylidene chloride, vinyl isobutyl ether and vinyl acetate. Examples of olefin monomers are ethylene, propylene, butadiene and isoprene and chlorinated or fluorinated derivatives thereof such as tetrafluroethylene. Examples of maleic monomers are maleic acid, maleic anhydride and maleimide.

Examples of acrylic polymers are poly(methyl methacrylate) and poly(butyl methacrylate), as well as carboxylated acrylic copolymers as sold for example by Ciba under the tradenames Ciba® Glascol® LE15, LS20 and LS24, styrene acrylic copolymers as sold for example by Ciba under the tradenames Ciba® Glascol® LS26 and Ciba® Glascol® C44, and polyacrylic acid polymers as sold for example by Ciba under the tradename Ciba® Glascol® E11.

Styrene polymers can be polymers formed from at least one styrene monomer and at least one vinyl monomer, olefin monomer and/or maleic monomer. Examples of styrene polymers are styrene butadiene styrene block polymers, styrene ethylene butadiene block polymers, styrene ethylene propylene styrene block polymers and styrene-maleic anhydride copolymers.

Vinyl polymers can be polymers formed from at least one vinyl monomer or from at least one vinyl monomer and at least one olefin monomer or maleic monomer. Examples of vinyl polymers are polyvinyl chloride, polyvinylalcohol, polyvinylacetate, partially hydrolysed polyvinyl acetate and methyl vinyl ether-maleic anhydride copolymers. Examples of derivatives thereof are carboxy-modified polyvinyl alcohol, acetoacetyl-modified polyvinyl alcohol, diacetone-modified polyvinyl alcohol and silicon-modified polyvinyl alcohol.

Polyolefins can be polymers formed from at least one olefin monomer or from at least one olefin monomer or maleic monomer. Examples of polyolefines are polyethylene, polypropylene, polybutadiene and isopropylene-maleic anhydride copolymer

Aldehyde polymers can be polymers formed from at least one aldehyde monomer or polymer and at least one alcohol monomer or polymer, amine monomer or polymer and/or urea monomer or polymer. Examples of aldehyde monomers are formaldehyde, furfural and butyral. Examples of alcohol monomers are phenol, cresol, resorcinol and xylenol. An example of polyalcohol is polyvinyl alcohol. Examples of amine monomers are aniline and melamine. Examples of urea monomers are urea, thiurea and dicyandiamide. An example of an aldehyde polymer is polyvinyl butyral formed from butyral and polyvinylalcohol.

Epoxide polymers can be polymers formed from at least one epoxide monomer and at least one alcohol monomer and/or amine monomer. Examples of epoxide monomers are epichlorhydrine and glycidol. Examples of alcohol monomers are phenol, cresol, resorcinol, xylenol, bisphenol A and glycol. An example of epoxide polymer is phenoxy resin, which is formed from epichlorihydrin and bisphenol A.

Polyamides can be polymers formed from at least one monomer having an amide group or an amino as well as a carboxy group or from at least one monomer having two amino groups and at least one monomer having two carboxy groups. An example of a monomer having an amide group is caprolactam. An example of a diamine is 1,6-diaminohexane. Examples of dicarboxylic acids are adipic acid, terephthalic acid, isophthalic acid and 1,4-naphthalene-dicarboxylic acid. Examples of polyamides are poyhexamethylene adipamide and polycaprolactam.

Polyesters polymers can be polymers formed from at least one monomer having an hydroxy as well as a carboxy group or from at least one monomer having two hydroxy groups and at least one monomer having two carboxy groups or a lactone group. An example of a monomer having a hydroxy as well as a carboxy group is adipic acid. An example of a diol is ethylene glycol. An example of a monomer having a lactone group is carprolactone. Examples of dicarboxylic acids are terephthalic acid, isophthalic acid and 1,4-naphthalene-dicarboxylic acid. An example of a polyester is polyethylene terephthalate. So-called alkyd resins are also regarded to belong to polyester polymers.

Polyurethane can be polymers formed from at least one diisocyanate monomer and at least one polyol monomer and/or polyamine monomer. Examples of diisocyanate monomers are hexamethylene diisocyanate, toluene diisiocyanate and diphenylmethane diiscocyanate.

Examples of sulfone-based polymers can be polyarylsulfone, polyethersulfone, polyphenyl-sulfone and polysulfone. Polysulfone is a polymer formed from 4,4-dichlorodiphenyl sulfone and bisphenol A.

Examples of natural polymers are starch, cellulose, gelatine, caesin and natural rubber. Examples of derivatives are oxidised starch, starch-vinyl acetate graft copolymers, hydroxyethyl cellulose, hydroxypropyl cellulose, methyl cellulose, ethyl cellulose, carboxymethyl cellulose and acetyl cellulose.

The polymeric binders are known in the art and can be produced by known methods, e.g. by polymerisation starting from suitable monomers.

Preferably, the polymeric binder is selected from the group consisting of acrylic polymers, styrene polymers, vinyl polymers and derivatives thereof, polyolefins, polyurethanes and natural polymers and derivatives thereof.

More preferably, the polymeric binder is selected from the group consisting of acrylic polymers, styrene butadiene copolymers, styrene-maleic anhydride copolymers, polyvinyl alcohol, polyvinyl acetate, partially hydrolysed polyvinyl acetate, methyl vinyl ether-maleic anhydride copolymers, carboxy-modified polyvinyl alcohol, acetoacetyl-modified polyvinyl alcohol, diacetone-modified polyvinyl alcohol and silicon-modified polyvinyl alcohol, isopropylene-maleic anhydride copolymer, polyurethane, cellulose, gelatine, caesin, oxidised starch, starch-vinyl acetate graft copolymers, hydroxyethyl cellulose, methyl cellulose, ethyl cellulose, carboxymethyl cellulose and acetyl cellulose.

Most preferably, the polymeric binder is styrene butadiene copolymer and/or polyvinyl alcohol.

The undercoating layer can also comprise additional components. Examples of additional components are stabilizers, surfactants, insolubilisers, lubricants, UV absorber, IR absorber, pH-adjusting agents, antioxidants, smoke suppressant, dispersants, rheology modifiers, wetting agents, fluorescent whitening agents and biocides. Preferred additional components are UV absorber, IR absorber, pH-adjusting agents, antioxidants, smoke suppressant, dispersants, rheology modifiers, wetting agents and biocides.

Examples of stabilisers are 2,2′-methylene-bis(4-methyl-6-tert-butylphenol), 2,2′-methylene-bis(4-ethyl-6-tert-butylphenol), 4,4′-butylidene-bis(3-methyl-6-tert-butylphenol), 4,4′-thio-bis(2-tert-butyl-5-methylphenol), 1,1,3-tris(2-methyl-4-hydroxy-5-tert-butylphenyl) butane, 1,1,3-tris(2-methyl-4-hydroxy-5-cyclohexylphenyl) butane, bis (3-tert-butyl-4-hydroxy-6-methylphenyl) sulfone, bis (3,5-dibromo-4-hydroxyphenyl) sulfone, 4,4′-suifinyl bis (2-tert-butyl-5-methylphenol), 2,2′-methylene bis (4,6-di-tert-butylphenyl) phosphate and alkali metal, ammonium and polyvalent metal salts thereof, 4-benzyloxy-4′-(2-methylglycidyloxy) diphenyl sulfone, 4,4′-diglycidyloxydiphenyl sulfone, 1,4-diglycidyloxybenzene, 4-[α-(hydroxylmethyl)benzyloxy]-4-hydroxydiphenyl sulfone, metal salts of p-nitrobenzoic acid, metal salts of phthalic acid mono benzyl ester, metal salts of dnnamic acid, 2,2′,3,3′-tetrahydro-3,3,3′, 3′-tetramethyl-1,1′-spribi-(1H-indene)-6,6′-diol and mixtures thereof.

Examples of surfactants are sodium dioctylsulfosuccinate, sodium dodecybenzenesulfonate, sodium lauryl sulfate and fatty acid metal salts.

Examples of insolubilisers are glyoxal, urea-formaldehyde resins, melamine formaldehyde resins, polyamide resins, polyamido-epichlorohydrin resins, adipic acid dihydrazide, boric acid, borax, ammonium zirconium carbonate, potassium zirconium carbonate and ammonium zirconium lactate.

Examples of lubricants are stearamide, methylene bis stearamide, polyethylene wax, carnauba wax, paraffin wax, zinc stearate, calcium stearate and mixtures thereof. A preferred lubricant is zinc stearate.

An example of a UV absorber is 2-hydroxy-4-methoxybenzophenone.

IR absorbers can be organic or inorganic. Examples of organic IR absorbers are alkylated triphenyl phosphorothionates, for example as sold under the trade name Ciba® Irgalube® 211 or Carbon Black, for example as sold under the trade names Ciba® Microsol® Black 2B or Ciba® Microsol® Black C-E2.

Examples of inorganic IR absorbers are oxides, hydroxides, sulfides, sulfates and phosphates of metals such as copper, bismuth, iron, nickel, tin, zinc, manganese, zirconium and antimony, including antimony(V) oxide doped mica and tin(IV) oxide doped mica, pH-Adjusting agents can be organic or mineral acids such as acetic acid or hydrochloric acid or bases such as sodium hydroxide.

An example of a smoke suppressant is ammonium octamolybdate.

Examples of a dispersants are Ciba® Dispex® N40, an acrylic acid, sodium salt copolymer, sodium naphthalene sulfonate polymer with formaldehyde.

Examples of rheology modifiers are xanthan gum, methylcellulose, hydroxypropyl methyl-cellulose, or acrylic polymers such as sold under the tradenames Ciba® Rheovis® 112, Ciba® Rheovis® 132 and Ciba® Rheovis® 152.

An example of a wetting agent is Ciba® Irgaclear® D, a sorbitol based clarifying agent.

Examples of fluorescent whitening agents are are stilbene derivatives such as sold, for example, under the tradenames Ciba® Tinopal® SPP-Z or Ciba® Tinopal® ABP-Z.

Examples of biocides are Acticide® MBS, which includes a mixture of chloromethyl isothiazolinone and methyl isothiazolinone, Biocheck® 410, which includes a combination of 2-dibromo-2,4-dicyanobutane and 1,2-benzisothiazolin-3-one, Biochek® 721 M, which includes a mixture of 1,2-dibromo-2,4-dicyanobutane and 2-bromo-2-nitro-1,3-propandiol and Metasol® TK 100, which includes 2-(4-thiazolyI)-benzimidazole. The undercoating layer can comprise 1 to 99%, preferably 40 to 98%, more preferably, 60 to 97%, most preferably 80 to 96% by dry weight of the pigment based on the dry weight of the undercoating layer.

The undercoating layer can comprise 1 to 80%, preferably 1 to 60%, more preferably, 1 to 30%, most preferably 1 to 20% by dry weight of the binder based on the dry weight of the undercoating layer.

The undercoating layer can comprise 0.05 to 20%, preferably 0.05 to 10%, more preferably, 0.1 to 5% by dry weight of the additional components based on the dry weight of the undercoating layer.

The recording layer can be any recording layer which comprises a system that undergoes a colour change upon heat treatment with the proviso that the system does not comprise an organic leuco dye and an organic colour developer.

Examples of systems that undergo a colour change upon heat treatment are systems selected from the group consisting of
A) an oxygen containing chromium, molybdenum and tungsten compound
B) a salt of an acid and an amine or mixtures of salts of acids and amines
C) an acid derivative
D) a compound containing a free carbonyl group and a nucleophile or a compound containing a free carbonyl group, which compound is substituted with one or more nucleophilic groups
E) titanium dioxide and
F) a compound having functional groups and a metal compound or an acid,

### Regarding System A:

Examples of oxygen containing chromium, molybdenum and tungsten compounds are chromium, molybdenum and tungsten oxides, alkali metal, earth alkaline metal, ammonium and mono-, di-, tri- and tetra-C₁₋₈-alkylammonium mono-, di- and polychromates, -molbydates and -tungstates, alkali metal, earth alkaline metal, ammonium and mono-, di-, tri- and tetra-C₁₋₈-alkylammonium heteropolychromates, -molybdates and -tungstates, alkali metal, earth alkaline metal, ammonium and mono-, di-, tri- and tetra-C₁₋₄-alkylammonium peroxo chromates, -molybdates and -tungstates, and hydroxyl containing chromates, molybdates and tungstates. Preferably, the oxygen containing transition metal compound is selected from the group consisting of alkali metal, ammonium and mono-, di-, tri- and tetra-C₁₋₈-alkyl-ammonium mono-, di- and polymolybdates and -tungstates. Examples of alkali metal and ammonium mono-, di- and polymolybdates and -tungstates are ammonium molybdate, sodium molybdate, potassium molybdate, ammonium dimolybdate, ammonium heptamolybdate, ammonium octamolybdate, ammonium decamolybdate, ammonium tungstate, sodium tungstate and potassium tungstate. More preferably, it is ammonium octamolybdate.

System A can also comprise an additive selected from the group consisting of organic acids, polyhydroxy compounds and bases as described in PCT/EP/2006064299.

Examples of organic acids are formic acid, acetic acid, butyric acid, lauric acid, lactic acid, 2,6-hexadienoic acid, undecylenic acid, ascorbic acid, oxalic acid, succinic acid, malic acid, tartaric acid, citric acid, fumaric acid, muconic acid, phenyl acetic acid, p-tolylacetic acid, 4-biphenylacetic acid, 4-methoxyphenylacetic acid, mandelic acid, α-acetamidocinnamic acid, 4-methylcinnamic acid, ferulic acid, trans-cinnamic acid and trans-styrylacetic acid.

Polyhydroxy compounds can be selected from the group consisting of carbohydrates such as monosaccharides, disaccharides and polysaccharides, and derivatives thereof wherein the carbonyl group has been reduced to a hydroxyl group, so-called sugar alcohols.

Examples of monosaccharides are glucose, mannose, galactose, arabinose, fructose, ribose, erythrose and xylose. Examples of disaccharides are maltose, cellobiose, lactose and sucrose. Examples of polysaccharides are cellulose, starch, gum arabic, dextrin and cyclodextrin. Examples of sugar alcohols are meso-erythritol, sorbitol, mannitol and pentaerythritol.

Examples of bases are sodium hydroxide, potassium hydroxide, magnesium hydroxide, calcium hydroxide, sodium carbonate, potassium carbonate, magnesium carbonate, calcium carbonate, ammonia, triethylamine, di- and tributylamine, di- and tripentylamine, di- and trihexylamine, mono-, di- and triethanolamine, N,N-dimethylethanolamine, ethylenediamine, 1,2- and 1,3-diaminopropane, aniline, morpholine, piperidine, pyrazine and pyrrolidine.

System A can also comprise a colour former.

### Regarding System B:

The acid can be inorganic or organic. Examples of inorganic acids are sulfuric acid, fluorosulfuric acid, chiorosulfuric acid, nitrosylsulfuric acid, thiosulfuric acid, sulfamic acid, sulfurous acid, formamidinesulfinic acid, nitric acid, phosphoric acid, thiophosphoric acid, fluorophosphoric acid, hexafluorophosphoric acid, polyphosphoric acid, phosphorous acid, hydrochloric acid, chloric acid, perchloric acid, hydrobromic acid, hydriodic acid and hydrofluoric acid. Examples of organic acids are sulfur-based organic acids such as 4-styrenesulfonic acid, p-toluenesulfonic acid, benzene sulfonic acid, xylene sulfonic acid, phenol sulfonic acid, methane sulfonic acid, trifluormethane sulfonic acid, poly(4-styrene sulfonic acid) and coplymers comprising 4-styrene sulfonic acid units such as poly(4-styrene-sulfonic acid-co-maleic acid), phosphor-based organic acids such as phenyl phosphonic acid, methane phosphonic acid, phenyl phosphinic acid, 2-aminoethyl dihydrogenphosphate, phytic acid, 2-phospho-L-ascorbic acid, glycero dihydrogenphosphate, diethylenetriamine penta(methylenephosphonic acid) (DTPMP), hexamethylenediamine tetra(methylene-phosphonic acid) (HDTMP), nitrilotris(methylene phosphonic acid) and 1-hydroxyethylidene diphosphonic acid, and carboxylic acids such as tartaric acid, dichloroacetic acid, trichloroacetic acid, oxalic acid and maleic acid.

Preferably, the acid is selected from the group consisting of inorganic acids, sulfur-based organic acids, phosphor-based organic acids, carboxylic acids and mixtures thereof. More preferably, the acid is selected from the group consisting of sulfuric acid, thiosulfuric acid, sulfurous acid, phosphoric acid, polyphosphoric acid, phosphorous acid, hydrochloric acid, sulfur-based organic acids, phosphor-based organic acids, carboxylic acids and mixtures thereof. Most preferably, the acid is sulphuric acid or phosphoric acid.

The amine can be of formula NR¹R²R³, wherein R¹, R² and R³ can be the same or different and are hydrogen, C₁₋₃₀-alkyl, C₂₋₃₀-alkenyl, C₄₋₈-cycloalkyl, C₅₋₈-cycloalkenyl, aralkyl, aralkenyl or aryl, or R¹ is hydrogen, C₁₋₃₀-alkyl, C₂₋₃₀-alkenyl, C₄₋₈-cycloalkyl, C₅₋₈-cycloalkenyl, aralkyl, aralkenyl or aryl and R² and R³, together with the nitrogen of the amine of formula NR¹R²R³ form a 5- to 7-membered ring, whereby C₁₋₃₀-alkyl, C₂₋₃₀-alkenyl, C₄₋₈-cycloalkyl, C₅₋₈-cycloalkenyl, aralkyl and aralkenyl can be unsubstituted or substituted with NR⁴R⁵R⁶, imino, cyano, cyanamino, hydroxy and/or C₁₋₈-alkoxy, and aryl can be unsubstituted or substituted with NR⁴R⁵R⁶, cyano, cyanamino, hydroxyl, C₁₋₆-alkyl, and/or C₁₋₄-alkoxy, wherein R⁴, R⁵ and R⁶ can be the same or different and are hydrogen, C₁₋₆-alkyl, C₄₋₈-cycloalkyl or aryl.

Examples of C₁₋₃₀-alkyl are methyl, ethyl, propyl, isopropyl, butyl, sec-butyl, isobutyl, tert-butyl, pentyl, hexyl, heptyl, octyl, nonyl, decyl, undecyl, dodecyl, myristyl, palmityl, stearyl and arachinyl. Examples of C₂₋₃₀-alkenyl are vinyl, allyl, linolenyl, docosahexaenoyl, eicosapentaenoyl, linoleyl, arachidonyl and oleyl. Examples of C₄₋₈-cyclalkyl are cyclopentyl and cyclohexyl. An example of C₅₋₈-cycloalkenyl is cyclohexenyl. Examples of aralkyl are benzyl and 2-phenylethyl. Examples of aryl are phenyl, 1,3,5-triazinyl or naphthyl. Examples of C₁₋₆-alkyl are methyl, ethyl, propyl, isopropyl, butyl, sec-butyl, isobutyl, tert-butyl, pentyl, and hexyl. Examples of C₁₋₄-alkoxy are methoxy, ethoxy, propoxy, isopropoxy and butoxy.

Preferred C₁₋₃₀-alkyls are C₁₋₁₀-alkyl, more preferred C₁₋₃₀-alkyls are C₁₋₆alkyl. Preferred C₂₋₃₀-alkenyls are C₂₋₁₀-alkyenyl, more preferred C₂₋₈-alkenyl. Examples of C₁₋₆-alkyl are given above. Examples of C₁₋₁₀-alkyl are methyl, ethyl, propyl, isopropyl, butyl, sec-butyl, isobutyl, tert-butyl, pentyl, hexyl, heptyl, octyl, nonyl and decyl. Examples of C₂₋₁₀-alkenyl and C₂₋₆-alkenyl are vinyl and allyl.

Examples of amines of formula NR¹R²R³ are ammonia, tris(hydroxymethyl)aminomethane, guanidine, methylamine, ethylamine, propylamine, butylamine, diethylamine, ethylene diamine, 1,2-diaminopropane, ethanolamine, triethanolamine, cyclohexylamine, aniline, melamine, methylolmelamine, pyrrole, morpholine, pyrrolidine and piperidine.

Preferably, the amine is of formula NR¹R²R³, wherein R¹ is hydrogen and R² and R³ are as defined above.

More preferably, the amine is of formula NR¹R²R³, wherein R¹ and R² are hydrogen and R³ is as defined above.

Most preferably, the amine is ammonia.

Preferably, system B comprises ammonium sulphate, ammonium phosphate, ammonium hydrogenphosphate or ammonium dihydrogenphosphate or mixtures of ammonium sulphate and ammonium phosphate, ammonium hydrogenphosphate or ammonium dihydrogenphosphate.

Preferably system B can also comprises a char forming compound. A char forming compound is a compound which forms char upon energy treatment. Generally, a char forming compound is of high carbon and oxygen content.

Examples of char forming compounds are carbohydrates such as monosaccharides, disaccharides and polysaccharides, and derivatives thereof wherein the carbonyl group has been reduced to a hydroxyl group, so-called sugar alcohols.

Examples of monosaccharides are glucose, mannose, galactose, arabinose, fructose, ribose, erythrose and xylose. Examples of disaccharides are maltose, cellobiose, lactose and saccharose. Examples of polysaccharides are cellulose, starch, gum arabic, dextrin and cyclodextrin. Examples of sugar alcohols are meso-erythritol, sorbitol, mannitol and pentaerythritol.

Preferred char forming compounds are monosaccharides and disaccharides. More preferred char forming compounds are saccharose and galactose. The most preferred char forming compound is saccharose.

System B can also comprise a colour former, although this is not preferred.

Examples of system B are described in PCT/EP/2006066064.

### Regarding System C:

Acid derivatives can be esters, amides, anhydrides and thioesters of an acid as defined above, wherein all acidic OH-groups are substituted with OR⁷, NR⁸R⁹, OC(O)R¹⁰ or SR¹¹, wherein R⁷, R⁸, R⁹, R¹⁰ and R¹¹ can be the same or different and can be hydrogen, C₁₋₃₀-alkyl, C₂₋₃₀-alkenyl, C₄₋₈-cycloalkyl, C₅₋₈-cycloalkenyl, aralkyl, aralkenyl or aryl, whereby C₁₋₃₀-alkyl, C₂₋₃₀-alkenyl, C₄₋₈-cycloalkyl, C₅₋₈-cycloalkenyl, aralkyl and aralkenyl can be unsubstituted or substituted with NR¹²R¹³R¹⁴, halogen, cyano, hydroxy and/or C₁₋₆-alkoxy, and aryl can be unsubstituted or substituted with NR¹²R¹³R¹⁴, halogen, cyano, hydroxyl, C₁₋₆-alkyl, and/or C₁₋₆-alkoxy, whereby R¹², R¹³ and R¹⁴ can be the same or different and are hydrogen, C₁₋₆-alkyl, C₄₋₈-cycloalkyl or aryl, provided that R⁷ is not hydrogen.

Examples of halogens are chlorine and bromine.

Examples of acid derivatives are ethyl p-toluenesulfonic acid ester, cyclohexyl p-toluene-sulfonic acid ester, dimethyl hydrogen phosphonate, dimethyl methyl phosphonate and trimethylphosphate. Preferred acid derivatives are esters of an acid as defined above, wherein all acidic OH-groups are substituted with OR⁷.

System C can also include a colour former, although this is not preferred.

### Regarding System D:

The compound containing a free carbonyl group can be any compound containing a carbonyl group, which is capable of reacting with a nucleophile such as an amine. Examples of compounds containing a free carbonyl group are aldehydes, ketones and reducing carbohydrates.

Examples of aldehydes are formaldehyde, acetaldehyde, propanal, butanal, pentanal, hexanal, benzaldehyde, salicylaldehyde and phenylacetaldehyde.

Examples of ketones are acetone, butanone, 2-pentanone, 3-pentanone, 3-methyl-2-buta-none, 1-phenyl-2-propanone, acetophenone, benzophenone and ascorbic acid (vitamin C).

Aldehydes and ketones can also be present in form of a hemiacetal, respectively, hemiketal. Hemiacetals and hemiketals can be formed from the respective aldehyde and ketal by reaction with one equivalent of an alcohol such as methanol, ethanol, isopropanol, propanol, butanol, pentanol, phenol, benzylalcohol and cyclohexanol.

Reducing carbohydrates are capable of reducing Tollens' reagent. Examples of reducing carbohydrates are aldoses, ketoses, reducing disaccharides and reducing polysaccharides.

Examples of aldoses are glycerinaldehyde, erythrose, threose, arabinose, ribose, xylose, lyxose, glucose, mannose, allose, altrose, gulose, idose, galactose and talose. Examples of ketoses are dihydroxyacetone, erythrulose, ribulose, xylulose, fructose, sorbose and tagatose. Examples of reducing dissacharides are maltose, cellubiose and lactose.

Preferred compounds containing a free cartbonyl group are ascorbic acid and glucose.

The nucleophile can be any nucleophile capable of reacting with the free carbonyl group of the compound containing the free carbonyl group. For example, the nucleophile can be an amine.

Examples of amines are ammonia, tris(hydroxymethyl)aminomethane, guanidine, methylamine, ethylamine, propylamine, butylamine, diethylamine, ethylene diamine, 1,2-diaminopropane, ethanolamine, triethanolamine, cyclohexylamine, aniline, melamine, pyrrole, morpholine, pyrrolidine, piperidine and polyetheramines such as those sold by Huntsmann under the tradename Jeffamine®, for example Jeffamine® D-230, which is a polypropyleneglycol carrying two terminal amino groups and having a molecular weight of 230 g/mol.

The amine can also be an amino acid or an amino sugar.

Examples of aminoacids are 4-aminohippuric acid and 4-aminobenzoic acid and the “standard” amino acids, which are glycine, alanine, valine, leucine, isoleucine, proline, phenylalanine, tyrosine, tryphthophane, cysteine, methionine, serine, threonine, lysine, arginine, histidine, aspartic acid, glutamic acid, asparagine and glutamine.

Amino sugars are carbohydrates which contain an amino group in place of a hydroxyl group, which is not the glycosidic hydroxyl group. Examples of amino sugars are glucosamine and galactosamine.

Preferably, the amine is an amino acid.

Any compound containing a free carbonyl group, which compound is substituted with one or more nucleophilic groups can be used, for example the compound containing a free carbonyl group, which compound is substituted with one or more nucleophilic groups, can be any of the compounds containing a free carbonyl group listed above, except that it is substituted with one or more nucleophilic groups. Preferred nucleophilic groups are amino groups. Examples of compounds containing a free carbonyl group, which compound is substituted with one or more amino groups, are amino sugars. Examples of amino sugars are listed above.

System D can also comprise a char forming compound.

### Regarding System E:

Titanium dioxide can be in the rutile, brookite or antasase form. Preferably, Titanium dioxide is in the anatase form (also called octahedrite), a tetragonal mineral of dipyramidal habit. The titanium dioxide in the anatase form can have a particle size in the range of 0.001 to 1000 p.m (1 nm to 1 mm). Preferably, the particle size is in the range of 0.01 to 10 μm, more preferably, it is in the range of 0.01 to 1 μm, most preferably it is in the range of 0.01 to 0.5 μm.

### Regarding System F:

Systems comprising a compound having functional groups and a metal compound or an acid are described, for example, in WO 2006/068205. The compound having a functional group can be a polyhydroxy compound such as hydroxypropyl cellulose, methylhydroxycellulose or polyvinyl alcohol, or a compound carrying halogen or ester functionalities such as polyvinyl chloride or polyvinyl acetate. Examples of metal compounds are magnesium chloride, magnesium hydroxide, calcium oxide and zinc oxide. An example of an acid is p-toluenesulfonic acid.

Among the systems listed above that undergo a colour change upon heat treatment systems A, B, C, D and E are preferred. Systems A, B, C and D are particularly preferred. System B, a salt of an acid and an amine or mixtures of salts of acids and amines, is the most preferred system.

The recording layer can also comprise a binder. Examples of binders are given above. Most preferably, the polymeric binder for the recording layer is polyvinyl alcohol or an acrylic polymer as sold for example by Ciba under the tradename Ciba® Glascol® such as Ciba® Glascol® LE15, LS26, El 1 or C44. Ciba® Glascol® LS 26 is a core shell polymer consisting of 70 weight parts 55/45 (w/w) styrene/2-ethylhexyl acrylate copolymer, which functions as the core polymer, and 30 weight parts of styrene/acrylic acid copolymer, which functions as the shell polymer. Particular preferred are polymeric binder for the recording layer.

Preferably, the recording layer can also comprise additional components. Examples of additional components are pigments, stabilizers, lubricant, UV absorber, IR absorber, pH-adjusting agents, antioxidants, smoke suppressant, dispersants, rheology modifiers, wetting agents, fluorescent whitening agents and biocides. Examples of pigments, stabilizers, surfactants, insolubilizers, lubricants, UV absorber, IR absorber, pH-adjusting agents, antioxidants, smoke suppressant, dispersants, rheology modifiers, wetting agents, fluorescent whitening agents and biocides are given above.

The recording layer can comprise 10 to 90%, preferably 20 to 80%, more preferably, 30 to 70%, most preferably 40 to 60% by dry weight of the system that undergoes a colour change upon heat treatment based on the dry weight of the recording layer.

The recording layer can comprise 10 to 90%, preferably 20 to 80%, more preferably, 30 to 70%, most preferably 40 to 60% dry weight of the binder based on the dry weight of the recording layer.

The recording layer can comprise 0.05 to 20%, preferably 0.05 to 10%, more preferably, 0.1 to 5% by dry weight of the additional components based on the dry weight of the recording layer.

The thickness of the undercoating layer, respectively, the recording layer is usually chosen to be in the range of 0.1 to 1000 μm. Preferably, it is in the range of 1 to 500 μm. More preferably, it is in the range of 1 to 200 μm. Most preferably, it is in the range of 1-20 μm.

The laser-sensitive recording material of the present invention can also comprise a laminate layer or overprint varnish. If the material of the laminate layer or the overprint varnish is selected so that it does not absorb at the wavelength of the imaging laser then the laser sensitive recording layer can be imaged through the laminate layer without damaging or marking the laminate. Also the laminate or overprint varnish is ideally chosen that it does not result in colouration of the recording layer before the laser treatment.

The substrate can be a sheet or any other three dimensional object, it can be transparent or opaque and it can have an even or uneven surface. An example of a substrate having an uneven surface is a filled paper bag, such as a paper bag of cement. The substrate can be made from paper, cardboard, metal, wood, textiles, glass, ceramics and/or polymers. The substrate can also be a pharmaceutical tablet or foodstuff. Examples of polymers are polyethylene terephthalate, low density-polyethylene, polypropylene, biaxially orientated polypropylene, polyether sulfone, polyvinyl chloride polyester and polystyrene. Preferably, the substrate is made from paper, cardboard or polymer.

The present invention also comprises a process for the preparation of the laser sensitive recording material of the present invention, which process comprises the steps of coating a substrate with a composition forming the undercoating layer and then with a composition forming the recording layer.

The composition forming the undercoating layer usually comprises the pigment and optionally the binder and/or additional components. Preferably, it also comprises a solvent.

The composition forming the recording layer usually comprises the system that undergoes a colour change upon heat treatment and optionally the binder and/or additional components. Preferably, it also comprises a solvent.

The solvent can be water, an organic solvent or a mixture of water and an organic solvent.

Examples of organic solvents are C₁₋₄-alkanols, C₂₋₄-polyols, C₃₋₆-ketones, C₄₋₆-ethers, C₂₋₃-nitriles, nitromethane, dimethylsulfoxide, dimethylformamide, dimethylacetamide, N-methyl pyrolidone and sulfolane, whereby C₁₋₄-alkanols and C₂₋₄-polyols may be substituted with C₁₋₄-alkoxy, and mixtures thereof. Examples of C₁₋₄-alkanols are methanol, ethanol, propanol, isopropanol or butanol, isobutanol, sec-butanol and Cert-butanol. Examples of a C₁₋₄-alkoxyderivatives thereof are 2-ethoxyethanol and 1-methoxy-2-propanol.

Examples of C₂₋₄-polyols are glycol and glycerol. Examples of C₃₋₆-ketones are acetone and methyl ethyl ketone. Examples of C₄₋₆-ethers are dimethoxyethane, diisopropylethyl and tetrahydrofurane. An example of a C₂₋₃-nitrile is acetonitrile.

More preferably, the solvent is water or a mixture of water and an organic solvent.

Preferably, the organic solvent is selected from the group consisting of C₁₋₄-alkanols, C₂₋₄-polyols, C₃₋₆-ketones, dimethylformamide and dimethylacetamide, whereby C₁₋₄-alkanols and C₂₋₄-polyols may be substituted with C₁₋₄-alkoxy.

Preferably, the ratio of water/organic solvent of the mixture of water and organic solvent is at least 0.5/1, and more preferably, at least 1/1.

Most preferably, the solvent is water.

The substrate can be coated with the composition forming the undercoating layer, respectively, the recording layer using a standard coating application such as a bar coater application, rotation application, spray application, curtain application, dip application, air application, knife application, blade application or roll application. The compositions can also be applied to the substrate by various printing methods such as silk screen printing, gravure printing, offset printing and flexo printing. If the substrate is paper, the composition can also be applied in the size press or at the wet-end of the paper machine.

The compositions forming the undercoating layer, respectively, recording layer can be dried, for example at ambient or elevated temperature. The elevated temperature is ideally chosen to avoid image formation before exposure to laser treatment.

Also part of the invention is a process for marking the laser-sensitive recording material of the present invention, which process comprises the step of exposing those parts of the laser-sensitive recording material, where a marking is intended, to laser irradiation in order to generate a marking.

Laser irradiation can be applied using a UV, visible or IR laser. Examples of IR lasers are CO₂ lasers, Nd:YAG lasers and IR semicoductor lasers.

Preferably, an IR laser is used. More preferably, the Ir laser has a wavelength in the range of 780 to 1,000,000 nm. Even more preferably, IR laser is a CO₂ laser or a Nd:YAG laser. Most preferably, the IR laser is a CO₂ laser having a wavelength of 10,600 nm.

Typically the exact power of the IR laser and the line speed is determined by the application and chosen to be sufficient to generate the image, for example, when the wavelength of the IR laser is 10,600 nm and the diameter of the laser beam is 0.35 mm, the power is typically 0.5 to 4 W, and the line speed is typically 300 to 2,000 mm/s.

Yet another aspect of the invention is the marked laser-sensitive recording material, which is obtained by above process.

Also part of the invention is the use of the composition of the present invention for the marking of data on packaging in the security/track and trace field.

In the security/track and trace field, the laser-sensitive recording material of the present invention can be imaged using a high resolution laser to give very small codes that are invisible or nearly invisible to the human eye. The images could however be decoded with a device (for example digital camera/scanner, magnifying glass or camera equipped mobile phone) which would give a unique code. The specific high resolution image could be generated by a computer and could be in the form of a two dimensional barcode or other pattern. Once scanned, information could then be sent to a secure computer (wireless with mobile phone) which could then give specific information on authenticity, date of manufacture, location of manufacture etc. The high-resolution images are very difficult to reproduce using traditional printing methods.

The laser-sensitive recording material of the present invention has the advantage in that it enhances the performance of the laser irradiation. The performance of the laser irradiation is enhanced, for example, when the density of the produced colour is increased at a given combination of irradiation power and time or when a given density of the produced colour can be achieved with a combination of lower irradiation power and/or less time.

### EXAMPLES

### Example 1

### Preparation of Undercoating Compositions

Undercoating compositions are prepared by mixing the following ingredients in the given order: 154 g water, 1 g Ciba® Dispex® N40, which is an aqueous solution of an acrylic acid, sodium salt copolymer, 100 g pigment (see table 1 below), 30 g of a 10% by weight aqueous solution of polyvinylalcohol and 15 g of a 50% by weight solution of Dow latex DL950, which is a styrene butadiene latex. The precoating compositions of examples la to ld are adjusted to a solid content of 30% by weight by addition of water.

TABLE 1

| Example No | pigment |
|---|---|
| 1a | Ansilex ® 93, a calcinated kaolin |
| 1b | aluminium hydroxide |
| 1c | talc |
| 1d | amorphous silica |

### Example 2

### Preparation of an Acrylic Binder

To a 1 litre resin pot fitted with mechanical stirrer, condenser, nitrogen inlet, temperature probe and feed inlets was placed 98.9 g water and 483.9 g Joncryl® 8078, a solution of an ammonium salt of a low molecular weight styrene acrylic copolymer. The contents were heated to 85° C. and degassed with nitrogen for 30 minutes. A monomer phase was prepared by mixing 192.5 g styrene with 157.5 g 2-ethylhexyl acrylate. An initiator feed was prepared by dissolving 1.97 g ammonium persulfate in 63.7 g water. When the reactor was at temperature and degassed, 0.66 g ammonium persulfate was added to the reactor. After 2 minutes the monomer and initiator feeds were started appropriate to a 3 and 4 hour feed respectively. The reactor contents were maintained at 85° C. throughout the feeds. After completion of the feeds, the reactor contents were held for a further 1 hour at 85° C. before being cooled down to below 40° C. at which point 0.9 g Acticide LG, a biocide containing chlorinated and non-chlorinated methyl isothiazolones, was added. This resulted in an emulsion polymer of 49.2% solids, pH 8.3 and a Brookfield RVT viscosity of 1100 cPs.

### Example 3A

### Preparation of Recording Composition A

Ammonium sulfate (6.55 g) and D-(+)-saccharose (14.0 g) are dissolved in water (33.7 g). 40.25 g of the acrylic binder, prepared as described in example 2, is added and the resulting white emulsion is stirred for 2 hours.

### Example 3B

### Preparation of Recording Composition B

Ammonium sulfate (6.55 g), ammonium phosphate dibasic (6 g) and D-(+)-saccharose (15.0 g) are dissolved in a mixture of water (33.7 g) and 25% by weight aqueous ammonia (0.1 g). 40.25 g of the acrylic binder, prepared as described in example 2, is added and the resulting white emulsion is stirred for 2 hours.

### Example 4

Preparation of Paper Coated with an Undercoating Layer and a Recording Layer

The undercoating compositions of examples 1a to 1d are applied on non-precoated base paper having a basis weight of around 48 g/m² using K bar number 3 in order to generate a wet film of approximately 24 μm. The film is dried at 40° C. for 4 minutes to form an undercoating layer. The recording compositions A or B, prepared as described in examples 3A, respectively, 3B, are then applied to the undercoating layer by a 12 μm coating bar, followed by drying at ambient temperature to yield a recording layer. As a control, non-precoated base paper is directly coated with recording composition A, respectively, B. Coloured images are formed by treating the coated paper with a CO₂ IR laser (wavelength: 10′600 nm, power: 2 W, diameter of laser beam: 0.35 mm, line speed 1000 mm/s). The density of the images obtained with the papers having an undercoating layer is compared to the controls having no undercoating layer. The increase in density (with undercoating layer versus without undercoating layer) is shown in table 2 below.

TABLE 2

| Example | Undercoating composition | Recording | Increase in |
|---|---|---|---|
| No | (pigment) | composition | Image Density¹ |
| 4a | 1a (Ansilex ® 93, a | A | + |
| | calcinated kaolin) | | |
| 4b | 1b (aluminium hydroxide) | A | + |
| 4c | 1c (talc) | A | + |
| 4d | 1d (amorphous silica) | A | + |
| 4e | 1a (Ansilex ® 93, a | B | ++ |
| | calcinated kaolin) | | |

¹+ refers to an increase in density, ++ refers to a high increase in density.

1. A laser-sensitive recording material, which comprises a substrate being coated with a recording layer and an undercoating layer, wherein the recording layer comprises a system that undergoes a colour change upon heat treatment produced by laser irradiation and wherein the undercoating layer comprises a pigment with the proviso that the system of the recording layer that undergoes a colour change upon heat treatment produced by laser irradiation does not comprise an organic leuco dye and an organic colour developer.

2. The laser-sensitive recording material of claim 1, wherein the undercoating layer also comprises a polymeric binder.

3. The laser-sensitive recording material of claim 1, wherein the undercoating layer also comprises additional components.

4. A process for the preparation of the laser sensitive recording material of claim 1, which process comprises the steps of coating a substrate with a composition forming the undercoating layer and then with a composition forming the recording layer.

5. A process for marking the laser-sensitive recording material of claim 1, which process comprises the step of exposing those parts of the laser-sensitive recording material, where a marking is intended, to laser irradiation in order to generate a marking.

6. A marked laser-sensitive recording material obtainable by the process of claim 5.

7. (canceled)
